(19) United States
(12) Patent Application Publication
(10) Pub. No.: US 2015/0089647 A1
(43) Pub. Date: Mar. 26, 2015

(54) Distributed Sample Analysis

(71) Applicant: F-Secure Corporation, Helsinki (FI)

(72) Inventors: Paolo PALUMBO, Helsinki (FI); Andrew PATEL, Helsinki (FI)

(73) Assignee: F-Secure Corporation

(21) Appl. No.: 14/496,032

(22) Filed: Sep. 25, 2014

(30) Foreign Application Priority Data
Sep. 26, 2013 (GB) 1317085.7

(51) Int. Cl. H04L 29/06; G06F 17/30

(52) U.S. Cl. CPC H04L 63/145; G06F 17/30109
USPC 726/23

(57) ABSTRACT

A method of inspecting a file on a client computer in order to determine if the file is malicious. The client computer sends a hash of the file to a server. The server then compares the hash of the file to a database of hashes of known files, and uses results of the comparison to determine whether or not the file is unknown to the server. If the file is unknown, the server sends a request for a first security analysis of the file to the client computer. The client computer then performs the first security analysis on the file, modifies the results of the first security analysis by removing or hashing selected data from results, and sends the modified results of the first security analysis to the server. The server performs a second security analysis on the modified results in order to determine if the file is malicious.

### FIELD OF THE INVENTION

The present invention relates to the field of malware protection. In particular, the present invention relates to analysis of unknown files to detect potential malware.

### BACKGROUND

Anti-malware software relies on the creation of up-to-date detection and removal code for new malware. In order to create this code, samples of files containing the malware are collected and analysed by the antivirus provider. Heuristic techniques may be used to perform limited on-the-fly detection on client computers, by matching the behaviour or properties of a file to other known malware. Clients can only be fully protected against a threat once a sample has been acquired and analysed by the anti-malware provider. Some so-called “parasitic” malware may infect existing files, producing unique malicious samples. These samples may be detected by looking for the embedded code, but an initial sample (or samples) must still be analysed by the anti-malware provider in order to determine what code should be looked for. Other malware types exist, and different analysis may be used on different malware types, but each will require some form of in-depth analysis in order to characterise and define signatures and detection rules for new malware.

### SUMMARY

According to a first aspect, there is provided a method of inspecting a file on a client computer in order to determine if the file is malicious. The client computer sends a hash of the file to a server. The server then compares the hash of the file to a database of hashes of known files, and uses results of the comparison to determine whether or not the file is unknown to the server. If the file is unknown, the server sends a request for a first security analysis of the file to the client computer. The client computer then performs the first security analysis on the file, modifies the results of the first security analysis by removing or hashing selected data from results, and sends the modified results of the first security analysis to the server. The server performs a second security analysis on the modified results in order to determine if the file is malicious.

According to a further aspect, there is provided a method of inspecting a file on a client computer in order to determine if the file is malicious. The method is performed by a client computer. The client computer sends a hash of the file to a server, and receives a request for a first security analysis of the file from the server. The client computer performs a first security analysis on the file, modifies results of the analysis by removing or hashing selected data from the results, and sends the modified results to the server for a second security analysis to determine whether the file is malicious.

According to a further aspect, there is provided a method of inspecting a file on a client computer in order to determine if the file is malicious. The method is performed by a server. The server receives a hash of a file from a client computer, compares the hash of the file to a database of hashes of known files, and determines whether or not the file is unknown to the server using results of the comparison. If the file is unknown, the server sends a request for a first security analysis of the file to the client computer, receives results of the first security analysis of the file from the client computer, and performs a second security analysis on the results in order to determine if the file is malicious.

According to a further aspect, there is provided a client computer suitable for implementing the above aspects. The client computer comprises a transceiver and a file analysis engine. The transceiver is for communicating with a server. The transceiver is configured to send a hash of a file to the server and receive a request for a first security analysis from the server. The file analysis engine is for performing the first security analysis on the file, and modifying results of the first security analysis by removing or hashing selected data from the results. The transceiver is additionally configured to send the modified results to the server for a second security analysis to determine whether the file is malicious.

According to a further aspect, there is provided a server suitable for implementing the above aspects. The server comprises a transceiver, a database comparator, a malware analysis engine and a database of hashes of known files. The transceiver is for communicating with one or more client computers. The transceiver is configured to receive a hash of a file from a client computer. The database comparator is for comparing the hash of the file to a database of hashes of known files and to determine that the file is unknown using results of the comparison. The transceiver is further configured to send a request for a first security analysis to the client computer, and to receive results of the first security analysis from the client computer. The malware analysis engine is configured to perform a second security analysis on the results in order to determine if the file is malicious.

According to a further aspect, there is provided a computer program which, when run on a computer, causes it to perform a method or to behave as a client computer or server according to the above aspects. The computer program may be embodied in a computer program product.

### DESCRIPTION OF THE DRAWINGS

FIG. 1 is a flowchart illustrating conventional malware detection;

FIG. 2 is a flowchart illustrating malware analysis according to an embodiment;

FIG. 3 is a flowchart illustrating malware analysis according to a further embodiment;

FIG. 4 is a schematic illustration of a client computer;

FIG. 5 is a schematic illustration of a server.

### DETAILED DESCRIPTION

As stated above, an anti-malware system requires that the provider obtains samples of unknown files in order to perform a detailed analysis. However, it is not possible to automatically acquire samples from customer machines. Submission of samples must involve the user's consent, since these samples are often documents which may contain confidential or personal information. Therefore, current solutions rely heavily on samples for which a publicly available source can be found.

A solution is proposed herein to aid and expedite the analysis of unknown samples found on client computers, in order to ensure that an anti-malware system's users are protected more quickly and efficiently. When an unknown sample is first encountered, it is analysed on the client computer. The results of this analysis are anonymised to remove any personal or confidential data, and then sent to a central server where they are acted upon (possibly including further analysis). The data submitted is anonymous and cannot be traced back to the client machines, thus ensuring that privacy is maintained. If the sample is deemed to be malicious, detection and/or removal code can be generated from the analysis, which can be included in future database updates, ensuring that other users of the anti-malware system are protected.

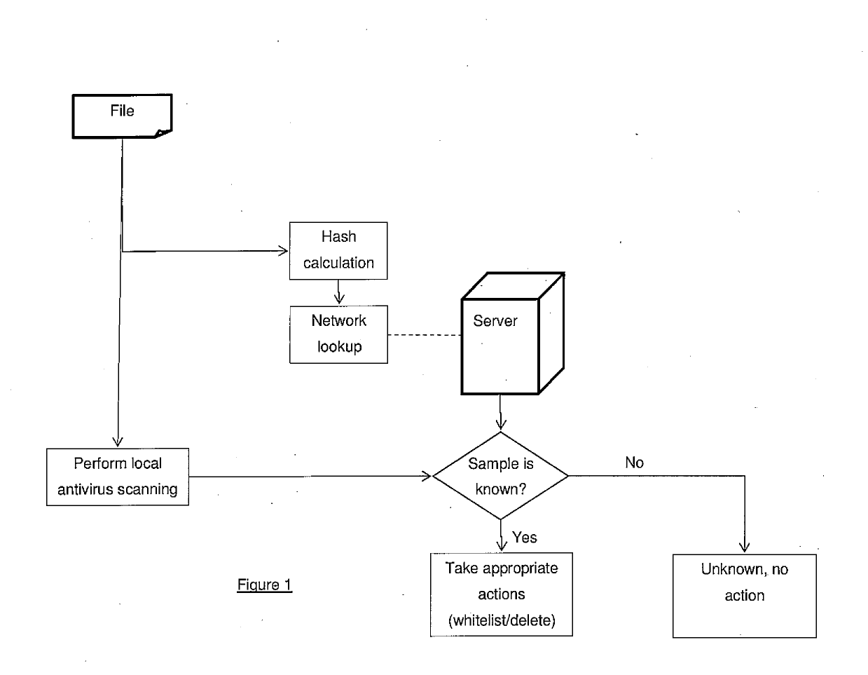

In a first embodiment, client side anti-malware software detects the arrival of a new file on a client's system (e.g. when a file is downloaded from the network or copied from an external drive). The anti-malware software will perform a scan on the new file. This scan will comprise comparing the file against a local database of known safe and malicious files, sending a hash of the file to the anti-malware vendor's server so that it can be compared against a central database of known files, and performing heuristic analysis to determine if the file is unsafe. If the file is not a known safe or unsafe file, and the heuristic analysis does not indicate that the file is likely to be malware, then the overall verdict for the file is “unknown”. In current solutions, no action is taken on unknown files (as shown in FIG. 1).

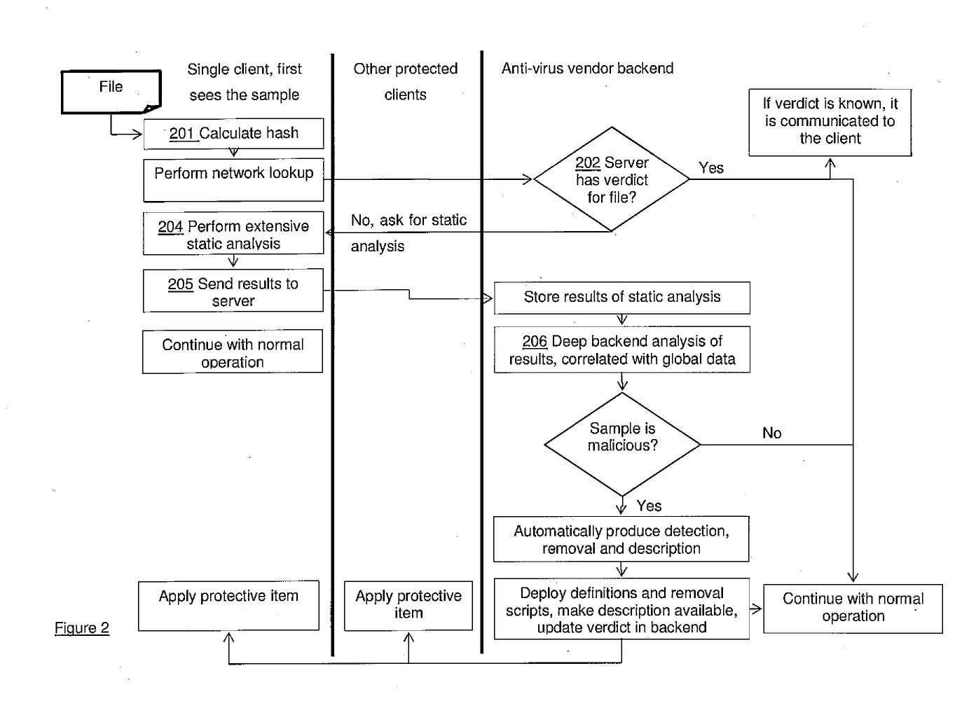

According to the first embodiment, as shown in FIG. 2, when the hash is sent to the server (201), and the server determines that the file is unknown (202), the server sends a request for analysis to the client (203), and the client performs a static analysis on the file (204). The file is analysed using local software at the client side, and the results of the analysis are sent to the server (205). The server then performs further analysis on the results to determine if the file is malware (206).

The analysis software is configured to ensure that no personal or confidential information is collected, and that the final results do not identify the originating machine or user. For example, any strings or images in the file being analysed would be hashed before including them in the results, so that the original data cannot be extracted. The analysis may include (without limitation) analysis methods such as sandbox analysis and feature extraction. These methods may vary depending on the type of sample analysed (e.g. filetype, size, or other metadata of the file). Sandbox analysis involves emulating the execution of the file in a controlled, virtual environment and monitoring events which occur during the emulated execution. Feature extraction could, for the example of a portable executable (PE) file, involve extracting PE header information and strings. For document filetypes (e.g. PDF, .DOC), feature analysis may include extracting structural and other non-text features of the document. The analysis is designed to extract any information which may be relevant to the potential maliciousness of the file, without extracting any personal or confidential data.

The local analysis software may be provided to the client with the request for analysis, or the client may download the analysis software from the anti-malware provider upon receiving the request for analysis. This reduces the overall size of the anti-malware application for the majority of consumers, ensures that the local analysis software is always up-to-date, and may help to prevent malware creators from accessing the analysis software in order to discover and exploit any weaknesses in the local analysis software.

Information obtained from the analysis is then sent, in an anonymised and possibly encrypted format, to the anti-malware vendor. The anti-malware vendor can then act on the information which may include performing further analysis of the received results. This further, server side analysis may include (without limitation) machine learning and similarity analysis. The further analysis can be used to deliver a verdict on the sample's maliciousness as well as a description of the sample itself. For example, where the server receives behavioural information for a sample, the set of operations performed by the sample, as reported in the results, can be compared with previously known data about other malware, and a connection between the sample and a previously known malware family may be identified. After such a connection has been established, the description, detection, and removal logic for the malware family can be extended to include the new sample's characteristics. This information is then available to any client querying the same sample hash in the future.

If the sample is determined to be malicious, but not a clear match to any known malware family, the server side analysis may be used to automatically generate new detection and removal code for the sample, which can then be sent to clients as part of a subsequent anti-malware definitions update. This scenario is particularly useful for identifying new heuristic detections for polymorphic malware, where querying the file's hash against a database of known file is of little to no use.

The local analysis of the file will require significant resources on the client. Several measures can be taken to mitigate this. The client software may queue up the analysis for periods where the system is not in heavy use, or run the analysis at a low priority to minimise the impact on user experience. To prevent the software needlessly analysing files which are already queued on other client machines, the central server may coordinate the analysis of unknown files by instructing a client to perform analysis on a file only if another client has not been instructed to analyse that file. This can be managed by recording the hashes of unknown files indicated to the central server by client machines, and only instructing a client to perform analysis of a file if the hash for that file does not match either a known file or a previously indicated unknown file. The central server may be configured to clear old hashes from the table periodically to ensure that gaps are not left in the analysis if a client loses contact with the network. The analysis may also be limited only to certain types of files, for example it may include only files which have characteristics suggestive of malware, but not enough to be indicated as malware in heuristic analysis, or it may exclude files which are determined to have certain characteristics of clean files during heuristic analysis. Furthermore, the analysis may be stopped at any time, e.g. if a document is found to have the same structural properties as a known document and differ only in the contents, then there is no need for further analysis.

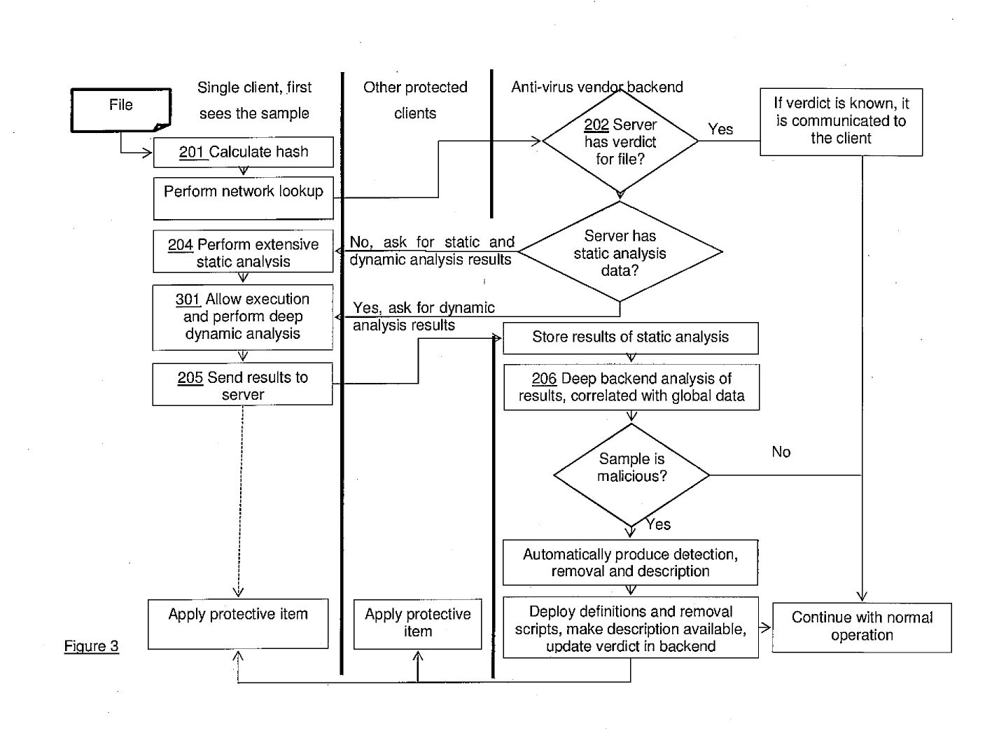

A second embodiment, shown in FIG. 3, is concerned with the dynamic analysis of unknown files running on the client. Similarly to the previous embodiment, when a file is opened or executed, it is first scanned by the local anti-malware (including checking against known safe and unsafe files), and queried to the central server (201). If the file is unknown (202), then the central server requests analysis (203), and dynamic analysis of the file will begin at the client computer (301). Static analysis (as in the first embodiment, 204) may or may not be run in addition to the dynamic analysis (e.g. depending on whether the server has static analysis data for the file). If static analysis is to be performed, execution or opening of the file may be blocked until the static analysis is finished. The results of the dynamic (and possibly static) analysis are sent to the server (205), which then analyses them to determine if the file is malware (206).

The behaviour of the file is monitored as it is being opened or executed, and the collected information is sent to the anti-malware provider's server for further analysis. The local monitoring and analysis may include (without limitation), monitoring file system activity, registry modifications, and/or network activity, memory analysis, mutex monitoring (examining mutual exclusion objects in memory for known or suspicious properties), and/or hooking of relevant system Application. Programming Interfaces (APIs). The data gathered will be anonymised (e.g. replacing IP addresses in network monitoring with other identifiers, hashing files accessed by the monitored file, etc.) and communicated to the anti-malware vendor. The analysis of the results at the central server may include (without limitation) advanced machine learning or similarity analysis, and will be used to update heuristic (real-time and non-real-time) detection rules for the sample and removal code for the sample.

The local anti-malware software may run heuristic real-time detection methods in parallel, and may terminate execution of the file (or of the program accessing the file) if behaviour indicative of malware is detected. If this occurs, all information gathered up to this point will be sent to the central server, which may allow for earlier detection of this malware family in future.

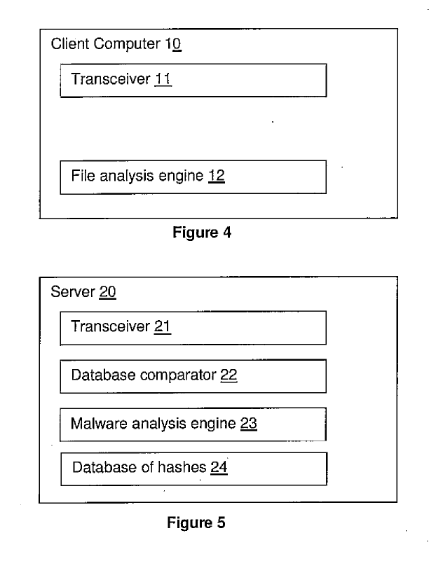

FIG. 4 illustrates schematically a client computer 10 suitable for implementing the above embodiments. The client computer 10 comprises a transceiver 11 and a file analysis engine 12. The transceiver 11 is for communicating with a server. The transceiver 11 is configured to send a hash of a file to the server and receive a request for a first security analysis from the server. The file analysis engine 12 is for performing the first security analysis on the file, and modifying results of the first security analysis by removing or hashing selected data from the results. The transceiver 11 is additionally configured to send the modified results to the server for a second security analysis to determine whether the file is malicious.

FIG. 5 illustrates schematically a server 20 suitable for implementing the above embodiments. The server 20 comprises a transceiver 21, a database comparator 22, a malware analysis engine 23 and a database of hashes of known files 24. The transceiver 21 is for communicating with one or more client computers. The transceiver 21 is configured to receive a hash of a file from a client computer. The database comparator 22 is for comparing the hash of the file to a database of hashes of known files 24 and to determine that the file is unknown using results of the comparison. The transceiver 21 is further configured to send a request for a first security analysis to the client computer, and to receive results of the first security analysis from the client computer. The malware analysis engine 23 is configured to perform a second security analysis on the results in order to determine if the file is malicious.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A method of inspecting a file on a client computer in order to determine if the file is malicious and improve the anti-malware protection of the client computer, the method comprising:
at the client computer:
sending a hash of the file to a server;
at the server:
comparing the hash of the file to a database of hashes of known files
using results of the comparison to determine whether or not the file is unknown to the server;
in the case that the file is unknown:
sending a request for a first security analysis of the file to the client computer;
at the client computer:
in response to receiving the request, performing said first security analysis on the file;
modifying the results of the first security analysis by removing selected data from results or by replacing selected data with a hash of the selected data;
sending the modified results of the first security analysis to the server; and
at the server:
performing a second security analysis on the modified results in order to determine if the file is malicious.

2. A method according to claim 1, wherein the selected data comprises any of:
strings;
images;
file metadata;
confidential data;
personal data; and
information about the client computer.

3. A method according to claim 1, wherein the first security analysis comprises any of:
extracting header information from the file;
extracting structural features of the file;
analysis of the code and/or data of the sample; and
opening or executing the file in a sandbox and monitoring events which occur in the sandbox.

4. A method according to claim 1, and comprising:
at the client computer:
detecting opening or execution of the file;
wherein the first security analysis comprises any of:
monitoring file system activity initiated by the file;
monitoring system setting changes initiated by the file;
monitoring network activity initiated by the file;
monitoring memory usage;
monitoring mutex objects created or accessed by the file; and
hooking system Application Programming Interfaces, APIs, called by the file.

5. A method according to claim 1, wherein the database of hashes of known files comprises a list of files on which analysis has been requested, and the method comprises:
at the server, in response to sending the request for analysis:
adding the file to the list of files on which analysis has been requested.

6. A method according to claim 1, and comprising, if the file is determined to be malware:
at the server:
using the results of the second security analysis to determine detection and/or removal code for the file.

7. A method according to claim 1, and comprising, if the file is determined to be malware:
at the server:
using the results of the second security analysis to determine a malware family to which the file belongs.

8. A method of inspecting a file on a client computer in order to determine if the file is malicious and improve the anti-malware protection of the client computer, the method comprising:
at a client computer:
sending a hash of the file to a server;
receiving a request for a first security analysis of the file from the server; performing a first security analysis on the file;
modifying results of the analysis by removing selected data from the results or by replacing selected data with a hash of the selected data; and
sending the modified results to the server for a second security analysis to determine whether the file is malicious.

9. A method according to claim 8, wherein the selected data comprises any of:
strings;
images;
file metadata;
confidential data;
personal data; and
information about the client computer.

10. A method according to claim 8, wherein the first security analysis comprises any of:
extracting header information from the file;
extracting structural features of the file;
analysis of the code and/or data of the sample; and
opening or executing the file in a sandbox and monitoring events which occur in the sandbox.

11. A method according to claim 8, and comprising:
detecting opening or execution of the file;
wherein the first security analysis comprises any of:
monitoring file system activity initiated by the file;
monitoring system setting changes initiated by the file;
monitoring network activity initiated by the file;
monitoring memory usage;
monitoring mutex objects created or accessed by the file; and
hooking system Application Programming Interfaces, APIs, called by the file.

12. A method of inspecting a file on a client computer in order to determine if the file is malicious and improve the anti-malware protection of the client computer, the method comprising:
at a server:
receiving a hash of a file from a client computer;
comparing the hash of the file to a database of hashes of known files;
determining whether or not the file is unknown to the server using results of the comparison;
in the case where the file is unknown:
sending a request for a first security analysis of the file to the client computer;
receiving results of the first security analysis of the file from the client computer; and
performing a second security analysis on the results in order to determine if the file is malicious.

13. A method according to claim 12, wherein the database of known files comprises a list of files on which security analysis has been requested, and the method comprises, in response to sending the request for the first security analysis:
adding the file to the list of files on which security analysis has been requested.

14. A method according to claim 12, and comprising, if the file is determined to be malware:
using the results of the second security analysis to determine detection and/or removal code for the file.

15. A method according to claim 12, and comprising, if the file is determined to be malware:
using the results of the second security analysis to determine a malware family to which the file belongs.

16. A computer comprising:
a transceiver for sending a hash of a file to a server and receiving a request for a first security analysis from the server;
a file analysis engine for performing the first security analysis on the file and modifying results of the first security analysis by removing selected data from the results or by replacing selected data with a hash of the selected data;
wherein the transceiver is additionally for sending the modified results to the server for a second security analysis to determine whether the file is malicious,

17. A server comprising:
a transceiver for receiving a hash of a file from a client computer;
a database of hashes of known files
a database comparator for comparing the hash of the file to a database of hashes of known files, and for determining whether or not the file is unknown using results of the comparison;
wherein the transceiver is additionally for sending a request for a first security analysis to the client computer in the case that the file is unknown, and receiving results of the first security analysis from the client computer;
a malware analysis engine for performing a second security analysis on the results in order to determine if the file is malicious.

18. A computer program comprising computer readable code, which, when run on a computer, causes it to perform a method according to claim 8.

19. A computer program product comprising a non-transitory computer readable medium and a computer program according to claim 18, wherein the computer program is stored on the computer readable medium.
